(19) United States
(12) Patent Application Publication
(10) Pub. No.: US 2024/0068288 A1
(43) Pub. Date: Feb. 29, 2024

(54) SLIDING PANEL SYSTEM

(71) Applicant: Viewline B.V., Oss (NL)

(72) Inventor: Knoed Jord Horck, Oss (NL)

(73) Assignee: Viewline B.V., Oss (NL)

(21) Appl. No.: 18/262,271

(22) PCT Filed: Jan. 21, 2022
(86) PCT No.: PCT/NL2022/050027

§ 371 Date: Jul. 20, 2023

(30) Foreign Application Priority Data
Jan. 22, 2021 (NL) 2027364

(51) Int. Cl. E05D 15/58; E04B 2/82; E05F 7/08

(52) U.S. Cl. CPC E05D 15/58; E04B 2/827; E05F 7/08; E05D 2015/586; E05Y 2900/142

(57) ABSTRACT

The invention relates to as sliding panel system. The system comprises a frame and a combination of one or more pivot panels and sliding panels. Each sliding panel is displaceable, in particular slidable, within the frame and part of the sliding panel can be fixated with respect to the frame such that the sliding panel can be pivotably displaced between a closed and an opened position.

The invention relates to a sliding panel system.

Sliding panel systems are often applied in building constructions and have many functional applications. The panels of the system form a wall coverage whereof the configuration is adaptable to the users preferences. When in its initial state, the panels form a wall covering wherein the panels are aligned in an adjacent and parallel orientation. Conventional systems apply a pivot panel positioned at one side of the system which could be applied as normal entrance whereas the further panels form a wall covering. However, when the opened pivot panel provides a space the adjacent panel(s) can be slid towards this space. A problem with conventional sliding panel systems is that fixation of the sliding panels with respect to the frame in order to enable the sliding panel to pivot is a challenge.

It is a goal of the invention to provide an improved sliding panel system, or at least provide an alternative to the know systems.

The invention provides thereto a sliding panel system, comprising at least one frame, the frame comprising at least one lower support rail, and at least one upper guide track, at least one pivot panel, connected or connectable to, preferably in a releasable manner, the frame and which pivot panel is configured to be pivotably displaced between at least a closed and an opened position, at least one sliding panel connected or connectable to, in particular between, the lower support rail and the upper guide track, wherein the sliding panel comprises at least one primary lower support carriage and at least one primary upper guide carriage, which are configured to enable that the sliding panel is displaceable, in particular slidable, along the frame, in particular along a longitudinal direction of the frame, and wherein at least part of the sliding panel can be fixated with respect to the frame such that the sliding panel can be pivotably displaced between at least a closed and an opened position, wherein at least one sliding panel comprises at least one displaceable hinge pin, which is displaceable between at least a retracted position and an extended position wherein the hinge pin (vertically) extends with respect to the sliding panel, and wherein the upper guide track comprises at least one receiving space for receiving at least part of the displaceable hinge pin when the hinge pin is in its extended position such that the hinge pin forms at least part of the pivot axis of the sliding panel.

The system according to the invention has several benefits over conventional sliding panel systems. That the sliding panel comprises a displaceable hinge pin, which is displaceable between a retracted position and an extended position wherein the hinge pin (vertically) extends with respect to the sliding panel and that the upper guide track comprises a receiving space for receiving at least part of the displaceable hinge pin when the hinge pin is in its extended position such that the hinge pin forms at least part of the pivot axis of the sliding panel enables that the sliding panel can be (temporarily) fixated within the frame such that the panel can be pivotably displaced within the frame, in particular between a closed and an opened position. In this way, the double function of the sliding panel, hence being able to act as wall part, in particular a displaceable wall part, and as a pivot panel, can be performed in a relatively simple but efficient manner. That the upper guide track comprises at least one receiving space is beneficial as in this manner the location of the pivot axis of the sliding panel can be pre-defined. The pivot hinge and the receiving space are typically configured for mutual co-action. Hence, the receiving space is typically configured and suitable to receive part of the hinge pin, in particular the distal (extending) end of the hinge pin.

The sliding panel system according to the invention could also be referred to as slide and swing panel system. The system is in particular a modular system. The sliding panel could also be referred to as sliding and pivot panel. The sliding panel could also be displaceable, in particular slidable, within the frame. At least one pivot panel could be connected or connectable to the frame, in particular between, the lower support rail and the upper guide track. However, it is also conceivable that at least one pivot panel is connect or connectable to a side wall of the frame. Such side wall could be an additional element which is fixed positioned between the upper guide track and the lower support rail. The system is preferably configured such that the weight of the panel(s) is carried by the lower support carriage(s). The upper guide carriage(s) are then configured to merely guide the panel(s) during displacement thereof. However, in a possible embodiment of the invention it is also conceivable that the upper guide rail carries the weight of the pane(s). The lower support carriage(s) fulfil then a guiding function. The frame is typically a substantially longitudinal frame. The guide track could also be referred to as guide rail. The support rail could also be referred to as support track. The carriage(s) could also be referred to as runner(s). Possibly the carriage(s) comprise(s) one or more rollers. The displaceable hinge pin can preferably be (temporarily) fixated in the retracted position and/or the extended position for example via applying at least one locking member.

Each pivot panel and/or sliding panel could possibly comprise at least one housing. For the inventive concept, it is not required that the panel is a massive panel. Hence when referred to a panel also a housing wherein a panel could be positioned can be meant. When pivot panel is in the opened position an opening is left free in the system. In case the pivot panel is in a fully opened position typically a person can pass through the provided opening. In the extended position, the hinge pin extends with respect to the sliding panel, in particular in a vertical manner. In the retracted position, the hinge pin is positioned within contours of sliding panel. Hence, in the retracted position the hinge pin does not extent with regard to the sliding panel, wherein it is prevented that the hinge pin negatively affects the ability to displace, in particular slide, the sliding panel along the frame, in particular along the lower support rail and the upper guide track. The hinge pin is typically displaceable in a linear manner.

It is conceivable that the system comprises at least one lower stop configured for engagement of at least part of the sliding panel, in particular the primary lower support carriage. The lower stop is in particular configured to restrict displacement of (the lower part of) the sliding panel along the frame in horizontal manner. The lower stop may for example be connected to the lower support rail. The application of a lower stop can further optimize the function change of the sliding panel. Do to the presence of at least one stop, the sliding panel can be positioned in a predetermined position. It is for example conceivable that the lower stop is positioned such that displacement of the sliding panel is substantially restricted (in a horizontal manner) when the hinge pin of the sliding panel is in line with a receiving space of the upper guide track. Preferably, the lower stop comprises at least one lower contact surface configured for engagement of at least part of the sliding panel, in particular the primary lower carriage. It is possible that the lower contact surface comprises a contact structure and that part of the sliding panel, and in particular the primary lower carriage comprises a complementary contact structure. In such embodiment, the co-action between the lower stop and the sliding panel can be improved.

In case at least one lower stop is applied, preferably, at least part of at least one lower stop is positioned inside the lower support rail. In this way, the lower stop does not negatively affect the external pathway of the lower support rail. It is in particular beneficial if at least one lower stop is positioned inside the lower support rail such that the lower support rail substantially encloses the lower stop. Hence, in case the sliding panel is positioned adjacent to the pivot panel, the lower stop can be positioned such that it will not hinder displacement of the pivot panel. Positioning of a lower stop inside the lower support rail is not only beneficial for safety reasons but also from aesthetic point of view.

In another beneficial embodiment, the system comprises at least one upper stop configured for engagement of at least part of the sliding panel, in particular the primary upper guide carriage. The upper stop is typically configured to restrict displacement of the (upper part of the) sliding panel along the frame in horizontal manner. The application of an upper stop can also further optimize the function change of the sliding panel and/or enable positioning of the sliding panel in a predetermined position. Preferably, the upper stop is positioned such that displacement of the sliding panel is substantially restricted (in a horizontal manner) when the hinge pin of the sliding panel is in line with a receiving space of the upper guide track. Preferably, the upper stop comprises at least one upper contact surface configured for engagement of at least part of the sliding panel, in particular the primary upper carriage. The upper stop can be connected to the upper guide track. The upper stop may also be at least partially enclosed by the upper guide track. Preferably, at least part of the upper stop is positioned within the upper guide track. It in particular beneficial if at least one upper stop is positioned substantially inside the upper guide track such that said upper stop is substantially enclosed by the upper guide track. In such embodiment it may be prevented that the upper stop interferes with the pivot panel and thus possibly hinders displacement of the pivot panel.

In case at least one lower stop and at least one upper stop are applied, it is beneficial if the lower stop and the upper stop are positioned such that a sliding panel which is displaced, in particular slid, along a longitudinal direction of the frame will first engage a lower contact surface of the lower stop prior to contacting an upper contact surface of the upper stop. This means that thus the sliding panel will contact the lower contact surface prior to contacting the upper contact surface. This will result in that tilting of the sliding panel will occur. Preferably the sliding panel is tilted over a predefined angle, which predefined angle is preferably less than 2 degrees, preferably less than 1 degree. The predefined angle can for example be in the range of 0.4 to 0.6 degrees. A (slight) tilt of the sliding panel will cause a lower corner of the sliding panel which was not into contact with the lower stop to (slightly) tilts. Hence, the contact surface between the sliding panel and the lower support rail is reduced. Said lower corner could for example be tilted at least 0.5 mm, preferably about 1 mm. The lower stop and the upper stop are preferably positioned such that a plane defined by the upper contact surface encloses an angle with the plane defined by the lower contact surface. It may also be said that the lower stop, and in particular the lower contact surface, is positioned at a horizontal distance from the upper stop, and in particular the upper contact surface.

It is beneficial if the lower stop comprises at least one adjustment element for adjusting the position of a lower contact surface of the lower stop. It would also be beneficial if the upper stop comprises at least one adjustment element for adjusting the position of an upper contact surface of the upper stop. The adjustment element could for example be an adjustment screw and/or an adjustment pin. Applying at least one adjustment element could contribute to further optimization of the positioning of the sliding panel in particular for its fixated position. In yet a further embodiment, the hinge pin, or components directly or indirectly affecting the position of the hinge pin (of the sliding panel) may also comprise an adjustment element. This could positively contribute to further optimization of the system and co-action between the components of the system.

In a beneficial embodiment, the primary lower support carriage comprises at least one limitation element for limiting the position of the primary lower support carriage with respect to the lower support rail, in particular at least in an opened position of the sliding panel. The limitation element could be configured to lock the mutual, relative, position of the support carriage and the lower support rail. The limitation element is preferably configured for co-action with the lower support rail. The lower support rail could for example comprise a receiving space for receiving at least part of the limitation element. The limitation element is possibly a displaceable limitation element, in particular configured to perform a pivotable or rotational displacement. It is also conceivable that the limitation element is substantially fixedly connected with the primary lower support carriage. The limitation element is then preferably activated when the sliding panel is displaced from a closed position to an opened position. It is beneficial to limit the position of the primary lower support carriage at least in the opened position as this could prevent undesired displacement of the sliding panel with respect to the lower support rail.

In yet another preferred embodiment, at least one sliding panel comprises at least one secondary lower support carriage. It is also conceivable that at least one sliding panel comprises at least one secondary upper guide carriage. The presence of a secondary lower support carriage and/or at least one secondary upper guide carriage could further contribute to an improved displacement of the sliding panel along the frame, in particular in a sliding manner. Further it may result in a more stable configuration of the sliding panel within the system. In a further specified embodiment, it is conceivable that the primary and/or secondary lower support carriage forms part of a lower stop for an adjacent further sliding panel, if applied. It is also imaginable that the primary and/or secondary upper guide carriage forms part of an upper stop for an adjacent further sliding panel. The secondary lower support carriage and/or secondary upper guide carriage may in fact form an integral stop for further sliding panels. It is also conceivable that part of the sliding panel forms an integral upper stop and/or an integral lower stop for a further sliding panel. In such embodiment, a relatively simple but efficient solution is obtained for the outlining, and subsequent (temporary) fixation, of an adjacent further sliding panel.

It is conceivable that at least one primary lower support carriage and at least one secondary lower support carriage are mutually connected. At least one primary upper guide carriage and at least one secondary upper guide carriage may also be mutually connected. The secondary lower support carriage can preferably be displaced and/or fixated in a predetermined position. The secondary lower support carriage can for example be displaceable between a supporting position, wherein the secondary lower support carriage is configured to contact the lower support rail and a pivot position. In the pivot position, there is no direct contact between the secondary lower support carriage and the lower support rail. Hence, pivoting of the sliding panel will not be hindered by the presence of the secondary lower support carriage. In fact, the secondary lower support carriage can be pulled upwards with regard to the sliding panel.

Possibly, at least one of the carriages comprises at least one locking element configured for locking the carriage in a predetermined position with regard to the sliding panel. Any of the primary lower support carriage, secondary lower support carriage, primary upper guide carriage and/or the secondary upper guide carriage could comprise such locking element. The locking element could for example also be configured to enable fall protection for the transmission rod(s) of an espagnolette, if applied.

In a preferred embodiment, the hinge pin is a spring loaded hinge pin. It is for example possible that at least part of the hinge pin co-acts with at least one spring, which spring could be activated thereby displacing the hinge pin from its retracted position to an extended position. The use of a spring loaded hinge pin enables easier operation and/or control of the hinge pin and may enable that manual operation can be omitted. Further, a spring loaded hinge pin could force the hinge pin to stay its extended position thereby providing a solid connection (and pivot axis) between the sliding panel and the upper guide rail. It is conceivable that the hinge pin is indirectly activated wherefor a spring loaded hinge could further contribute to the ease of use of the system.

At least one receiving space comprises preferably at least one protective layer. A protective layer can enable multiple and/or intensive use of the system wherein damage to the components is prevented. It is for example conceivable that the receiving space comprises a protective insert. The protective layer can provide more stability of the hinge pin when received in the receiving space. Further, the protective layer could also have a sound dampening effect. The protective layer could for example be made of a polymer-based material. It is also imaginable that the protective layer is made of a metal, preferably steel, more preferably chromium plated steel. It is preferred that the upper part of the hinge pin has a complementary shape to the inner surface of the receiving space. In this way part of the hinge pin can be received in the receiving space in an efficient and stable manner. In a beneficial embodiment of the system, the upper guide track comprises a plurality of receiving spaces, wherein each receiving space is configured for receiving at least part of a hinge pin. This embodiment provides more flexibility to the use of the system.

The upper guide track is preferably a single track. Hence, the upper guide track may have a single track configuration. The upper guide track may be configured to locate all sliding panel(s) and/or pivot panel(s) within the same (single) track. It is also conceivable that the lower support rail is a single rail. Hence, the lower support rail may have a single rail configuration. The lower support rail may thus be configures to locate all sliding panel(s) and/or pivot panel(s) within the same (single) rail. The system having a upper guide track which is a single track and wherein the lower support rail is a single rail benefits of a more reliable wind- and watertight configuration. This embodiment is further beneficial from spatial point of view.

The primary upper guide carriage could possibly comprise at least one blocking element. The blocking element can be a resilient and/or displaceable blocking element. The blocking element is preferably configured for co-action with the hinge pin and/or with the upper stop, if applied. The blocking element is for example configured to be displaced between at least an extended position wherein the blocking element substantially limits displacement of the hinge pin in particular to its extended position and a retracted position wherein the blocking element will provide an access opening for the hinge pin in particular such that the hinge pin can be displaced towards its extended position. Hence, the blocking element can in particular be configured to prevent, or limit, that the hinge pin is displaced to its extended position. Preferably, the blocking element is spring loaded. The blocking element is preferably configured such that when a sliding panel which is displaced, in particular slid, along a longitudinal direction of the frame the blocking element will contact an upper contact surface of the upper stop thereby causing the resilient blocking element to be pushed inwardly (in a direction facing away from the upper contact surface) such that the blocking element is displaced from the extended position to the retracted position. The blocking element can preferably be fixated in at least one predetermined position, for example in its retracted position when the sliding panel is in its position to function as pivot panel. When the blocking element is spring loaded, the blocking element can be automatically returned to its extended position when the contact between the blocking element and the hinge pin is removed. The blocking element then returns into its extended position to lock the hinge pin in its retracted position. The blocking element can be at least partially enclosed by the guide carriage. The primary upper guide carriage and/or the blocking element (if applied) may define at least one access opening. The blocking element could also be referred to as barrier element,

It is beneficial if the primary upper guide carriage encloses at least part of the hinge pin, at least when the hinge pin is in the extended position. It is also conceivable that the primary upper guide carriage encloses at least part of the hinge pin both extended and the retraction position of the hinge pin. The primary upper carriage can provide a protective and/or guiding function for the hinge pin. It is for example beneficial if the hinge pin co-acts with a central part of the primary upper guide carriage. In this way, a stable configuration of the system can be obtained. It is also conceivable that the hinge pin forms integral part of the primary upper guide carriage.

A preferred embodiment of the system according to the present invention comprises multiple sliding panels, wherein each sliding panel is connected or connectable to the lower support rail and the upper guide track, wherein each sliding panel comprises at least one primary lower support carriage, and at least one primary upper guide carriage, such that the sliding panel is displaceable, in particular slidable within the frame, and wherein the sliding panel is configured to be pivotably displaceable between a closed and an opened position. It is beneficial if the system further comprises a plurality of receiving spaces according to the present invention. The system may further comprises a plurality of upper stops and/or lower stops. Further, it is also conceivable that some upper and/or lower stops are formed by a primary upper guide carriage and/or a primary lower support carriage of a(n) (adjacent) sliding panel. The system may also comprise multiple pivot panels. The system can be a modular system, in particular an adaptable modular system. It is for example conceivable that the system comprises at least one stationary upper stop and/or at least one stationary lower stop. Additionally, or alternatively, the system may comprises at least one upper stop which forms part of a primary upper guide carriage and/or wherein the system comprises at least one lower stop which forms part of a primary lower support carriage.

It is beneficial if the sliding panel comprises at least one (manual) handle configured for directly or indirectly displacing the hinge pin between the retracted position and the extended position. In this way, the sliding panel could be operated manually in a relatively easy manner. The handle could for example be a latch. In a further preferred embodiment, the handle could be connected to the hinge pin via at least one transmission, in particular at least one corner transmission. In this way, the handle can be placed at a preferred position. The handle may also form part of an espagnolette. It is also conceivable that the sliding panel comprises at least one espagnolette, wherein an upper transmission rod of the espagnolette is at least coupled with the hinge pin (of the sliding panel). If present, a lower transmission rod of the espagnolette can be coupled with a secondary lower support carriage, if applied. Activating of the espagnolette causes displacement of the hinge pin and preferably displacement and/or fixation of the secondary lower support carriage in a predetermined position. The espagnolette preferably enables displaceable of the hinge pin between a retracted position and an extended position, or vice versa. The upper transmission rod of the espagnolette can be coupled with the hinge pin via at least one further transmission, for example but not limited to at least one corner transmission.

The upper transmission rod of the espagnolette could for example be coupled to the hinge pin via subsequently a first corner transmission, an assembly of transmission rod parts and a second corner transmissions. The upper transmission rod of the espagnolette could also coupled with the hinge pin and/or with at least one secondary upper guide carriage, if applied. The espagnolette could also be configured to displace at least part of the upper guide carriage and/or the lower support carriage. Typically the espagnolette comprises at least one (manual) handle. Possibly, the upper transmission rod is coupled with at least one locking element configured for locking a secondary upper guide carriage. The upper transmission rod could also be coupled with a transmission containing a mishandling device to prevent retraction and/or unlocking of the hinge pin when the slide-swing door is in its open position. A mishandling device could also be described as fall prevention device.

The pivot panel can for example be a pivot door or a pivot window. The pivot panel can also be a wicked door. The sliding panel can be a sliding door or a sliding window.

The invention will be further elucidated by means of non-limiting exemplary embodiments illustrated in the following figures, in which:

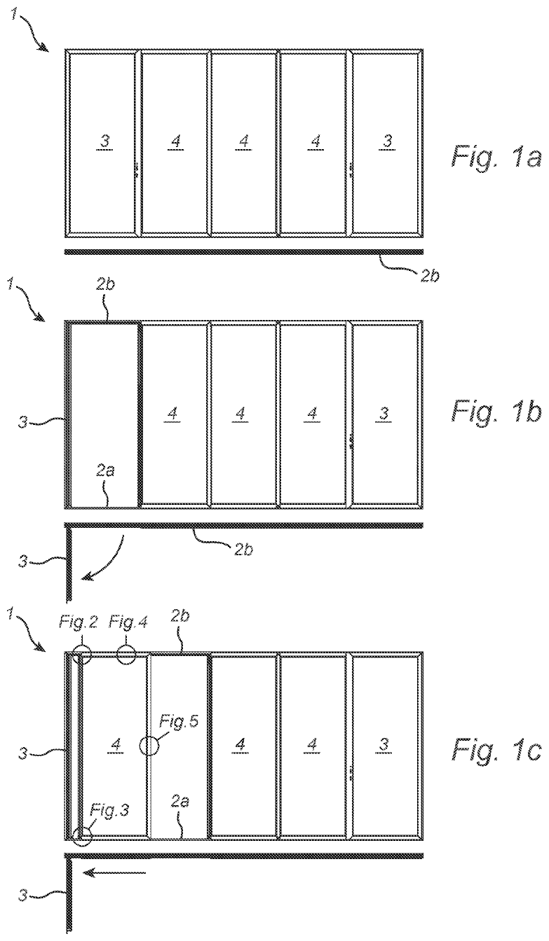

FIG. 1a-1e show a schematic representation of a possible embodiment of a system 1 according to the present invention;

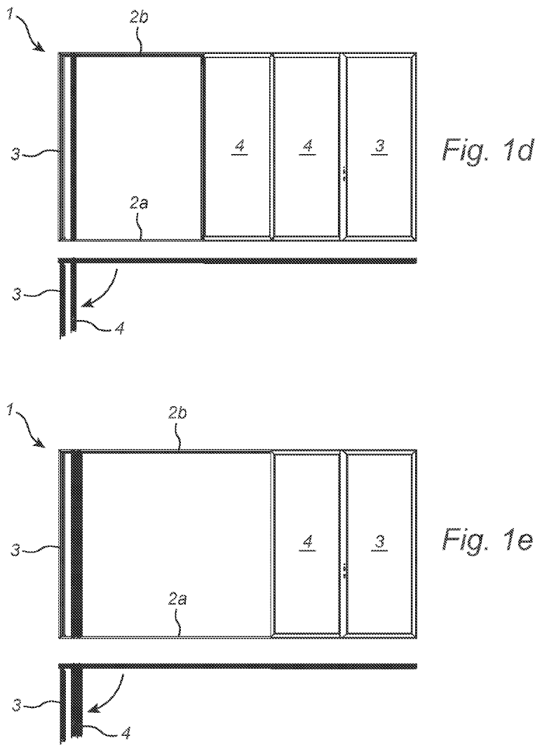

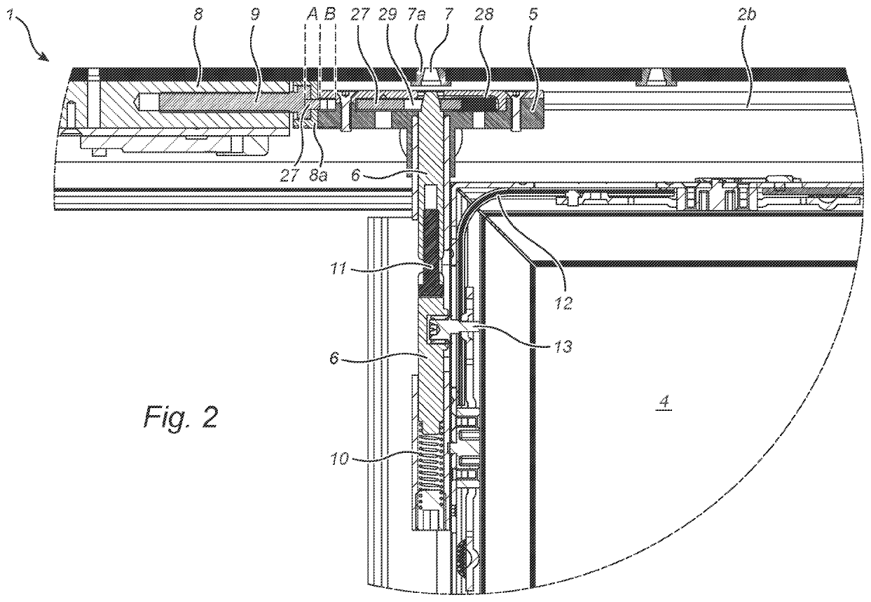

FIG. 2 shows a detailed view of part of the system as shown in FIGS. 1a-1e;

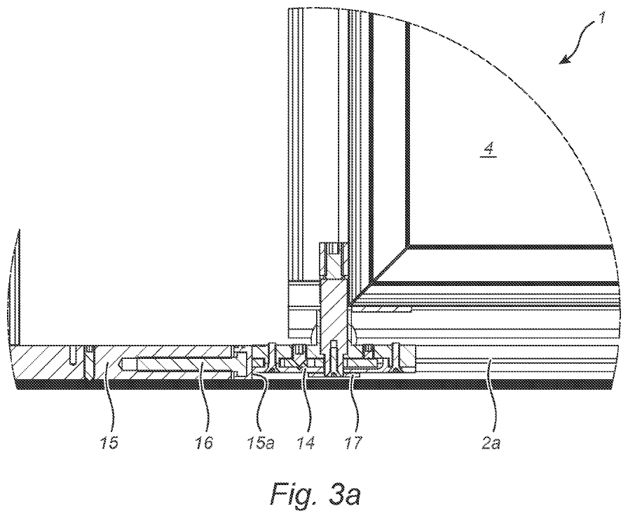

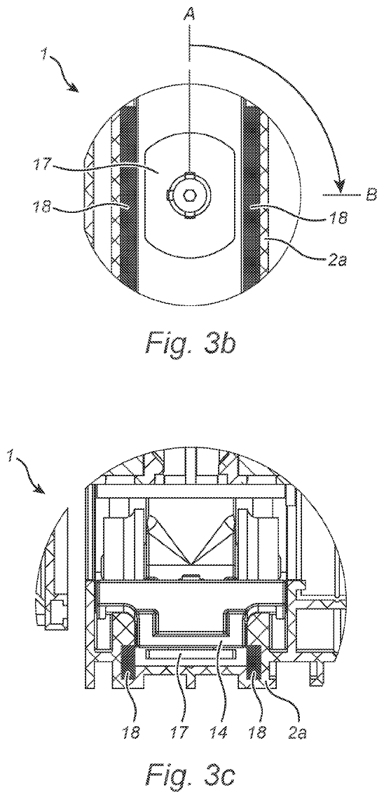

FIGS. 3a-3c show a detailed view of a further part of the system as shown in FIGS. 1a-1e;

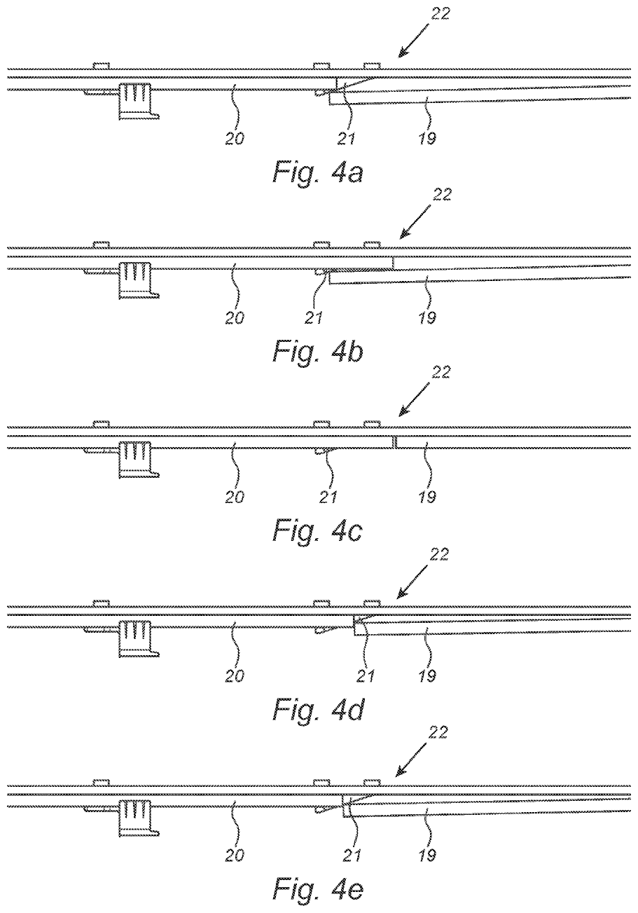

FIGS. 4a-4e also show a detailed view of part of the system as shown in FIGS. 1a-1e;

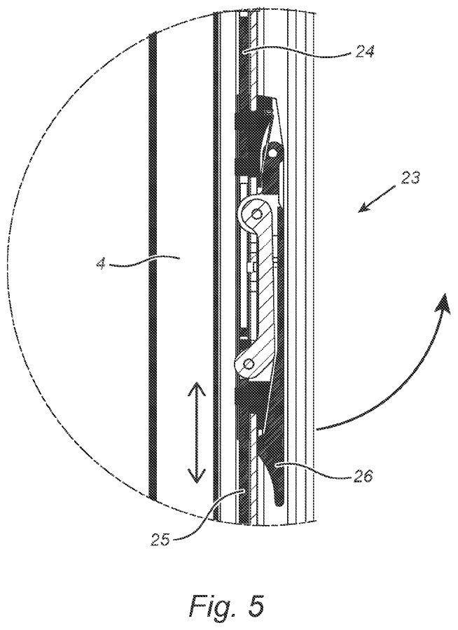

FIG. 5 shows a detailed view of yet another part of the system as shown in FIGS. 1a-1e; and

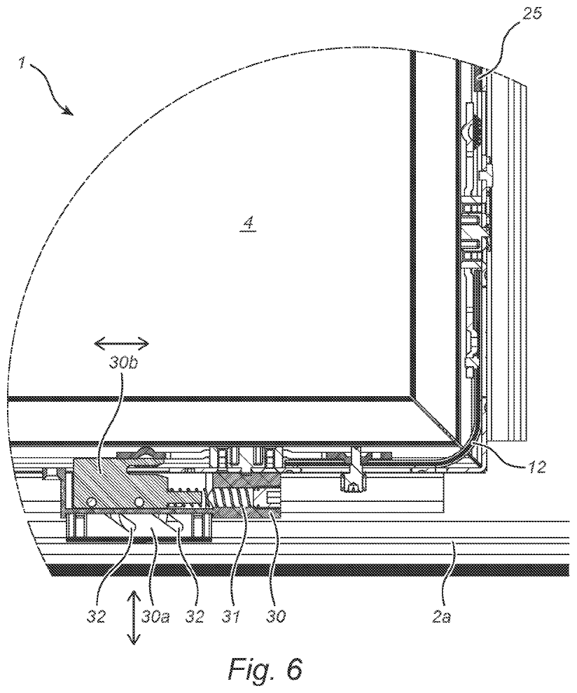

FIG. 6 shows a detailed view of part of the system as shown in FIGS. 1a-1e.

Within these figures, similar reference numbers correspond to similar or equivalent elements or features.

FIGS. 1a-1e show a schematic representation of a possible embodiment of a system 1 according to the present invention. Each FIG. 1a-1e shows a schematic side view and a schematic top view of a different configuration of the system 1. The system 1 as shown comprises a substantially longitudinal frame 2. The frame 2 comprises a lower support rail 2a and an upper guide track 2b. The system 1 as shown further comprises two pivot panels 3. Each pivot panel 3 is connected to, and between, the lower support rail 2a and the upper guide track 2b and configured to be pivotably displaced between a closed and an opened position. FIG. 1a shows an initial state of the system 1 wherein the panels 3, 4 form a wall covering wherein the panels 3, 4 are aligned in an adjacent and parallel orientation. FIG. 1a shows a closed position of a first pivot panel 3, whereas FIGS. 1b-1e show the first pivot panel 3 in an opened position. The system 1 as shown comprises a plurality of sliding panels 4. Each sliding panel 4 is connected to, and between, the lower support rail 2a and the upper guide track 2b. Further, each sliding panel comprises at least one primary lower support carriage (not shown) and at least one primary upper guide carriage (not shown) which are configured to enable that the sliding panel 4 is displaceable, in particular slidable, within the frame 2a, 2b along a longitudinal direction of the frame 2a, 2b. As shown in FIGS. 1c-1e, at least part of the sliding panels 4 can be fixated with respect to the frame 2a, 2b such that the sliding panel 4 can be pivotably displaced between a closed and an opened position. Each sliding panel 4 comprises at least one displaceable hinge pin (not shown), which is displaceable between a retracted position and an extended position wherein the hinge pin vertically extends with respect to the sliding panel 4. The upper guide track 2b comprises at least one receiving space (not shown) for receiving at least part of the displaceable hinge pin when the hinge pin is in its extended position such that the hinge pin forms at least part of the pivot axis of the sliding panel 4. The number of pivot panels 3 and sliding panels 4 is non-limiting and only shown for illustrative purpose. FIGS. 2-4 show more details about the system. In FIG. 1c the location of said details is indicated.

FIG. 2 shows a detailed view of part of the system 1 according to the present invention. The figure shows in particular a cross section of an upper corner of a sliding panel 4. The sliding panel 4 is fixated with respect to the frame 2b such that the sliding panel 4 can be pivotably displaced between a closed and an opened position. The present figure shows the sliding panel 4 in a closed position. The sliding panel 4 comprises a primary upper guide carriage 5 and a displaceable hinge pin 6 which is displaceable between a retracted position and an extended position. In the shown embodiment the hinge pin 6 is in a retracted position. In the extended position the hinge pin 6 would vertically extends with respect to the sliding panel 4 and would at least partly be received in a receiving space 7 present in the upper guide track 2b. When the hinge pin 6 is in its extended position, the hinge pin 6 forms part of a pivot axis of the sliding panel 4. The system 1 further comprises an upper stop 8 configured for engagement of at least part of the sliding panel 4, in particular the primary upper guide carriage 5. Part of the upper stop 8 is positioned within the upper guide track 2b. The upper stop 8 comprises at least one adjustment element 9 for adjusting the position of an upper contact surface 8a of the upper stop 8. It can be seen that part of the primary upper guide carriage 5 engages the upper contact surface 8a of the upper stop 8. Hence, in the shown configuration the sliding panel 4 is in a slightly tilted position. In the shown embodiment, the upper guide carriage 5 comprises a blocking element 27, in particular a resilient and/or displaceable blocking element 27. The blocking element 27 is configured for co-action with a spring 28 such that the blocking element 27 is displaceable in a substantially linear manner. Hence, the shown blocking element 27 is a spring loaded blocking element 27. The figure indicates that the distal end of the blocking element 27 is configured to be displaced between an extended position (A) and a retracted position (B). When the sliding panel is displaced such that the blocking element 27, and in particular the distal end thereof, engages the upper stop 8, the blocking element 27 will be displaced in a direction facing away from the upper stop 8. In fact, the blocking element 27 will be retracted with regard to the upper guide carriage 5. Consequently, the blocking element 27 will leave an access opening 29 free for the hinge pin 6. The access opening 29, defined by the upper guide carriage 5 and the blocking element 27, will enable displacement of the hinge pin 6 towards its extended position. In the extended position (A) of the blocking element 27, part of the blocking element 27 limits the displacement of the hinge pin 6. The hinge pin 6 is in line with the receiving space 7. The hinge pin 6 is a spring loaded hinge pin 6. The hinge pin 6 is configured for co-action with a spring 10. The hinge pin 6 further comprises an adjustment element 11 configured for optimization of the co-action between at least the hinge pin 6 and the receiving space 7. The receiving space 7 can be provided with at least one protective layer 7a. It can be seen that the upper part of the hinge pin 6 has a complementary shape to the inner surface of the receiving space 7. In the shown embodiment, the upper guide track 2b comprises a plurality of receiving spaces 7, wherein each receiving space 7 is configured for receiving at least part of a hinge pin 6. The primary upper guide carriage 5 encloses part of the hinge pin 6. The figure further shows the presence of a corner transmission 12, which is connected via a connection element 13 to the hinge pin 6. The corner transmission 12 can be activated via a handle (not shown) such that the hinge pin 6 can be activated in a relatively simple manner and at distance from the hinge pin 6.

FIGS. 3a-3c show a detailed view of part of the system 1 according to the present invention. FIG. 3a shows in particular a lower corner of a sliding panel 4. The sliding panel 4 is fixated with respect to the frame 2a such that the sliding panel 4 can be pivotably displaced between a closed and an opened position. The sliding panel 4 comprises a primary lower support carriage 14 which is configured to enable that the sliding panel 4 is displaceable, in particular slidable, within the frame 2b. Further, the system 1 comprises at least one lower stop 15 configured for engagement of at least part of the sliding panel 4, in particular the primary lower support carriage 14. Part of the lower stop 15 is positioned inside the lower support rail 2a. The lower stop 15 comprises an adjustment element 16 for adjusting the position of a lower contact surface 15a of the lower stop 15. FIGS. 3b and 3c show a further detailed view of the primary lower support carriage 14. The primary lower support carriage 14 comprises at least one limitation element 17 for limiting the position of said primary lower support carriage 14 with respect to the lower support rail. Position A is a sliding position and position B is an opened position of the sliding panel 4. It is to be understood that the limitation element 17 is configured for co-action with the lower support rail 2a, in particular with the resilient elements 18, such as a rubber 18.

FIGS. 4a-4e show a detailed view of yet another part of the system 1 according to the present invention. FIGS. 4a-4e show in particular an optional transmission 22 configured to facilitate easy and controlled operation of the sliding panel 4. The transmission 22 comprises a first transmission rod part 20 and a second transmission rod part 19, which are mutually connected via a coupling ramp 21. The transmission 22 could also be seen as an assembly of transmission rod parts 19, 20. It is conceivable that the transmission rod parts 19, 20 are connected to respectively the handle and the hinge pin via at least one corner transmission. An example of a corner transmission 12 to which the first transmission rod part 20 could be coupled can be seen in FIG. 2. The transmission 22 as shown is typically positioned at an upper region of the sliding panel 4. Theoretically, the transmission 22 could be present at any place between the hinge pin 6 and upper transmission rod 24. The second transmission rod part 19 could for example be connected with a transmission rod 24 of an espagnolette 23 (for example as shown in FIG. 5). In such embodiment, activation (opening) of the espagnolette will cause the upper transmission rod of the espagnolette to be pulled down. Consequently, the second transmission rod part 19 is therefore pulled towards the upper transmission rod (to the right in the shown figure). As a result thereof, the second transmission rod part 19 slides off the transmission rod 20, and will be aligned with the first transmission rod part 20. This configuration enables more controlled operation of the hinge pin.

Considering the first transmission rod part 19 is connected to the hinge pin via a corner transmission and the second transmission rod part 19 is via a further corner transmission connected with a transmission rod of an espagnolette, FIGS. 4a-4e show a sequence of the transmission 22 during use. Herein, FIG. 4a shows an initial (rest) configuration of the transmission 22. In this embodiment, the sliding panel (not shown) is typically in its sliding position and the espagnolette is closed. The hinge pin is in its retracted position, therefore enabling the panel to slide freely.

FIG. 4b shows a configuration of the transmission 22 wherein the hinge pin is locked in its extended position. Displacement of the hinge pin could for example be initiated by displacement of the blocking element 27 of the upper guide carriage 5 as shown in FIG. 2. Due to the displacement of the hinge pin, the first transmission part 20 of the transmission 22 is displaced.

FIG. 4c shows yet another configuration of the transmission 22 wherein the espagnolette is in a fully opened position. The second transmission rod part 19 is displaced towards the transmission configuration shown in this figure, after which the counter pressure of the pressure spring 31 of the secondary lower support carriage 30 (as shown in FIG. 6) can be overcome in order to displace the secondary lower support carriage from the supporting position to a pivot position. Hence, in this configuration, the secondary lower support carriage 30 is in its pivot position. This configuration enables to exert a compressive force on the first transmission rod part 20 via the second transmission rod part 19.

FIGS. 4d and 4e show intermediate configurations of the transmission 22 as shown in FIGS. 4a-4c. FIG. 4d shows the transmission 22 during a 20% closure of the espagnolette. The figure shows that the transmission rod parts 19, 20 are guided towards the initial (rest) configuration as shown in FIG. 4a. FIG. 4e shows the transmission 22 during a 60% closure of the espagnolette.

FIG. 5 shows a detailed view of yet another part of the system 1 according to the present invention. FIG. 5 shows a detailed view of an espagnolette 23 which could be applied to operate the system 1. The sliding panel 4 comprises an espagnolette 23 having an upper transmission rod 24 and a lower transmission rod 25, and a handle 26. The upper transmission rod 24 of espagnolette 23 is indirectly coupled with the hinge pin (of the sliding panel). In the shown embodiment, the upper transmission rod 23 is coupled with the second transmission rod part 19 of the transmission 22 shown in FIGS. 4a-4c. The lower transmission rod 25 of the espagnolette 23 can be coupled with a secondary lower support carriage (shown in FIG. 6). Activating of the espagnolette 23 via the handle 26 can cause displacement of the hinge pin and displacement of the secondary lower support carriage. The handle 26 is configuration for manual operation. The arrow in the figure indicate the direction of the displacement of the upper transmission rod 24, the lower transmission rod 25 and the handle 26. The upper transmission rod 24 could also be coupled with a locking element configured for locking a secondary upper guide carriage (not shown), if applied.

FIG. 6 show a detailed view of yet another part of the system 1 according to the present invention. The figure shows that the sliding panel 4 comprises an optional secondary lower support carriage 30. The secondary lower support carriage 30 is configured be displaced between a supporting position and a pivot position. The secondary lower support carriage 30 comprises thereto at least one displaceable carriage part 30a which is displaceably connected with a further part of the secondary lower support carriage 30 via a mechanical coupling means 32. The displaceable part 30a could for example comprise rollers configured for co-action with the lower support rail 2a. Possibly the secondary lower support carriage 30 can be fixated in at least one of the supporting position and the pivot position. In the shown embodiment, the secondary lower support carriage 30 is connected to the lower transmission rod 25 of the espagnolette via a corner transmission 12. The displacement of the displaceable part 30a of the secondary lower support carriage 30 is activated when the lower transmission rod 25 of the espagnolette is activated. The pressure spring 31 enables that the lower transmission rod of the espagnolette is hold in its position during the first step of activation of the espagnolette (activation of the upper transmission rod) since the pressure spring 31 provides a counter pressure.

The ordinal numbers used in this document, like “first” or “second” are used only for identification purposes. The expression “horizontal” and “vertical” are also used for indicating a common direction during normal use of most embodiments of the system according to the invention, but may deviate in alternative embodiments. Moreover, these directional expressions should not be interpreted to strictly. Typically, the system is placed onto or installed upon a horizontal surface or floor. Consequently, in a typical situation the sliding panel will be displaced along the frame in a horizontal (perpendicular to the aforementioned vertical direction), while e.g. the hinge pin may be displaceable in vertical direction parallel to the plane defined by the horizontal surface or floor.

It will be clear that the invention is not limited to the exemplary embodiments which are illustrated and described here, but that countless variants are possible within the framework of the attached claims, which will be obvious to the person skilled in the art. In this case, it is conceivable for different inventive concepts and/or technical measures of the above-described variant embodiments to be completely or partly combined without departing from the inventive idea described in the attached claims.

The verb ‘comprise’ and its conjugations as used in this patent document are understood to mean not only ‘comprise’, but to also include the expressions ‘contain’, ‘substantially contain’, ‘formed by’ and conjugations thereof.

1. Sliding panel system, comprising:
at least one frame, the frame comprising:
at least one lower support rail; and
at least one upper guide track;
at least one pivot panel, connected or connectable to the frame and configured to be pivotably displaced between a closed and an opened position;
at least one sliding panel, connected or connectable to the lower support rail and the upper guide track, wherein the sliding panel comprises:
at least one primary lower support carriage; and
at least one primary upper guide carriage;
which are configured to enable that the sliding panel is displaceable along the frame, and wherein at least part of the sliding panel can be fixated with respect to the frame such that the sliding panel can be pivotably displaced between a closed and an opened position;
wherein at least one sliding panel comprises at least one displaceable hinge pin, which is displaceable between a retracted position and an extended position wherein the hinge pin extends with respect to the sliding panel; and
wherein the upper guide track comprises at least one receiving space for receiving at least part of the displaceable hinge pin when the hinge pin is in its extended position such that the hinge pin forms at least part of the pivot axis of the sliding panel.

2. The sliding panel system according to claim 1, comprising at least one lower stop configured for engagement of at least part of the sliding panel.

3. The sliding panel system according to claim 2, wherein at least part of the lower stop is positioned inside the lower support rail such that the lower support rail substantially encloses the lower stop.

4. The sliding panel system according to claim 1, comprising at least one upper stop configured for engagement of at least part of the sliding panel.

5. The sliding panel system according to claim 4, wherein at least part of the upper stop is positioned inside the upper guide track such that the upper guide track substantially encloses the upper stop.

6. The sliding panel system of claim 1, comprising:
at least one lower stop configured for engagement of at least part of the sliding panel; and
at least one upper stop configured for engagement of at least part of the sliding panel;
wherein the lower stop and the upper stop are positioned such that a sliding panel which is displaced along a longitudinal direction of the frame will first engage a lower contact surface of the lower stop prior to contacting an upper contact surface of the upper stop.

7. The sliding panel system of claim 1, comprising:
at least one lower stop configured for engagement of at least part of the sliding panel; and
at least one upper stop configured for engagement of at least part of the sliding panel;
wherein the lower stop comprises at least one adjustment element for adjusting the position of a lower contact surface of the lower stop and/or wherein the upper stop comprises at least one adjustment element for adjusting the position of an upper contact surface of the upper stop.

8. The sliding panel system according to claim 1, wherein the primary lower support carriage comprises at least one limitation element for limiting the position of said primary lower support carriage with respect to the lower support rail.

9. The sliding panel system according to claim 1, wherein at least one sliding panel comprises at least one secondary lower support carriage and/or at least one secondary upper guide carriage.

10. The sliding panel system according to claim 1, wherein at least one of the carriages comprises at least one locking element configured for locking the carriage in a predetermined position with regard to the sliding panel.

11. The sliding panel system according to claim 1, wherein the hinge pin is a spring loaded hinge pin.

12. The sliding panel system according to claim 1, wherein at least one receiving space comprises at least one protective layer.

13. The sliding panel system according to claim 1, wherein the upper part of the hinge pin has a complementary shape to the inner surface of the receiving space.

14. The sliding panel system according to claim 1, wherein the upper guide track comprises a plurality of receiving spaces, wherein each receiving space is configured for receiving at least part of a hinge pin.

15. The sliding panel system according to claim 1, wherein the upper guide track is a single track and/or wherein the lower support rail is a single rail.

16. The sliding panel system according to claim 1, wherein the primary upper guide carriage encloses at least part of the hinge pin at least in the extended position.

17. The sliding panel system according to claim 1, wherein the primary upper guide carriage comprises at least one resilient blocking element which is configured to be displaced between at least an extended position wherein the blocking element substantially limits displacement of the hinge pin towards its extended position and a retracted position wherein the blocking element provides an access opening for the hinge pin.

18. The sliding panel system according to claim 1, comprising multiple sliding panels, wherein each sliding panel is connected or connectable to the lower support rail and the upper guide track, wherein each sliding panel comprises:
at least one primary lower support carriage; and
at least one primary upper guide carriage;
such that the sliding panel is displaceable, and wherein the sliding panel is configured to be pivotably displaceable between a closed and an opened position.

19. The sliding panel system according to claim 1, wherein the sliding panel comprises at least one handle configured for displacing the hinge pin between the retracted position and the extended position.

20. The sliding panel system according to claim 1, wherein the sliding panel comprises at least one espagnolette, wherein an upper transmission rod of the at least one espagnolette is at least coupled with the hinge pin and wherein a lower transmission rod of the at least one espagnolette is coupled with a secondary lower support carriage such that activating of the at least one espagnolette causes displacement of the hinge pin and displacement and/or fixation of the secondary lower support carriage in a predetermined position.
